(19) United States
(12) Patent Application Publication
(10) Pub. No.: US 2013/0110527 A1
(43) Pub. Date: May 2, 2013

(54) DENTAL CONSULTATION SYSTEM

(71) Applicant: Chun-Leon CHEN, Taipei City (TW)

(72) Inventor: Chun-Leon CHEN, Taipei City (TW)

(21) Appl. No.: 13/284,821

(22) Filed: Oct. 28, 2011

(51) Int. Cl. G06Q 50/22

(52) U.S. Cl. 705/2

(57) ABSTRACT

A dental consultation system includes a network, a computerized tomography scanner for obtaining a CT digital image file and pictures of the teeth in the oral cavity of a patient, a patient-end terminal for the input of the CT digital image file and pictures of a patient teeth that were obtained from the computerized tomography scanner and a consultation data, a Project Center for receiving the CT digital image file and pictures and consultation data transmitted by the patient-end terminal through the Internet and then providing a result of consultation containing a dental diagnostic report, a dental medical material data, a surgical guide data, a temporary denture data, a certified dentist data and a 5-in-1 dental implant surgery data and then feeding the result of consultation back to the patient-end terminal.

### BACKGROUND OF THE INVENTION

1. Field of the Invention

The present invention relates to dental technology and more particularly, to a dental consultation system, which enables a patient to get accurate dental diagnosis by means of a network.

2. Description of the Related Art

Following continuous progress in human's life-style and gradual change in versatile eating habit and eating amount, a large percentage of modern people suffer tooth decay. Further, following fast development of dental care technology, dental implant has become a popular surgery.

After removal of a decayed tooth, a dental implant may be necessary. As receiving a dental implant surgery costs a lot, a patient may consult many dental clinics before making a decision. However, consulting many dental clinics spend a lot of outpatient fee. Further, due to lack of medical knowledge, an ordinary person cannot determine which of the many consulted dental clinics to be mostly reliable. This problem is commonly seen in existing dental treatment. It is also a waste of medical resources to repeat the same diagnosis on one same patient in a different dental clinic.

Therefore, it is the main point to discuss how to help patients and dentists save diagnostic time.

### SUMMARY OF THE INVENTION

The present invention has been accomplished under the circumstances in view. It is one object of the present invention to provide a dental consultation system, which help patient and dentists save much time in dental diagnosis.

To achieve this and other objects of the present invention, a dental consultation system comprises a network, a computerized tomography scanner for obtaining a CT digital image file and pictures of the teeth in the oral cavity of a patient, a patient-end terminal for the input of the CT digital image file and pictures of a patient teeth that were obtained from the computerized tomography scanner and a consultation data, a Project Center for receiving the CT digital image file and pictures and consultation data transmitted by the patient-end terminal through the Internet and then providing a result of consultation containing a dental diagnostic report, a dental medical material data, a surgical guide data, a temporary denture data, a certified dentist data and a 5-in-1 dental implant surgery data and then feeding the result of consultation back to the patient-end terminal.

Further, the CT digital image file and pictures of the patient are inputted into the patient-end terminal at first, and then the consultation data is inputted into said patient-end terminal for transmitting to the Project Center through the Internet. The consultation data includes a planning fee, a patient data and personal requirements. The result of consultation is fed back by the Project center to the patient-end terminal for patient's acceptance and signature.

Further, the certified dentist data provided by the Project Center comprises a dentist certification, a dentist educational program, and purchase of dental medical materials by dentist member.

The dental consultation system provided by the present invention has the following advantages of:
1. Instead of spending much time and money to consult many dental clinics, any patient can obtain a reliable dental diagnostic report from the Project Center through a network after spent a limited amount of fee to get a CT digital image file and pictures of his (her) teeth from any local dental clinic and then carry the dental diagnostic report to a nearby certified dentist for implant surgery, saving much time and money.
2. A certified dentist can directly start implant surgery after having inspected the dental diagnostic report given by the patient without making any diagnosis from the beginning, thereby saving much labor and time.
3. A certified dentist must be continuously re-educated by the Project Center to get latest medical information, maintaining the leadership in technology.
4. After becoming a member of the Project Center, a dentist can purchase implant roots from the Project Center at a relatively lower price, lowering the medical cost.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is a system block diagram of a dental consultation system in accordance with the present invention.

FIG. 2 is a block diagram illustrating the details of the services of the patient-end terminal of the dental consultation system in accordance with the present invention.

FIG. 3 is a block diagram illustrating the details of the services of the Project Center of the dental consultation system in accordance with the present invention.

### DETAILED DESCRIPTION OF THE PREFERRED EMBODIMENT

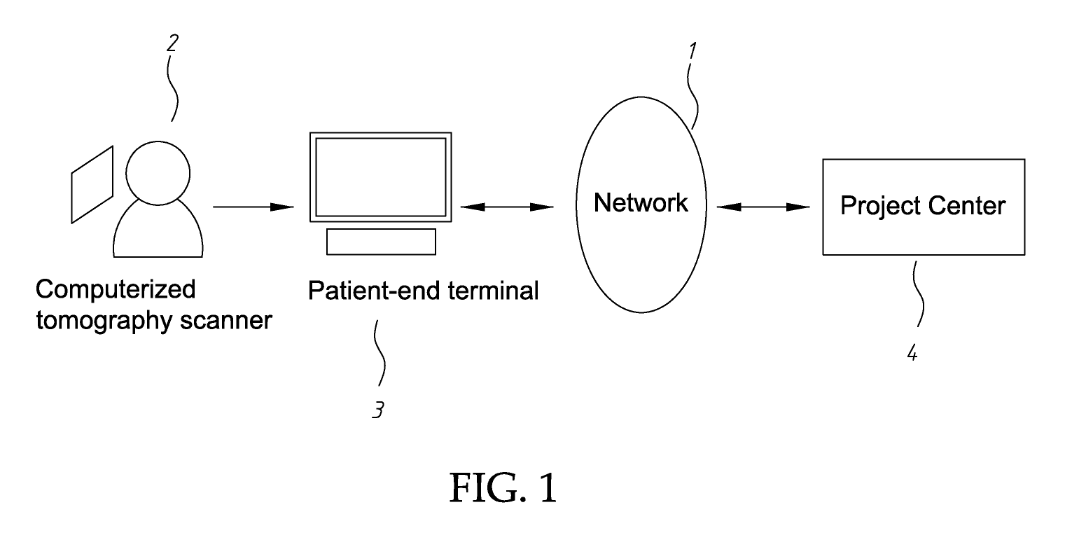

Referring to FIG. 1, a dental consultation system in accordance with the present invention is shown comprising a network 1, a computerized tomography scanner 2, a patient-end terminal 3 and a Project Center 4.

The network 1 can be wired network or wireless communication network. The computerized tomography scanner 2 is adapted for obtaining a CT digital image file and pictures of the teeth in the oral cavity of a patient. Of course, the computerized tomography scanner 2 can be installed in a dental clinic. A patient can pay a limit registration fee to the dental clinic and then get a CT digital image file and pictures of his (her) teeth from the computerized tomography scanner 2.

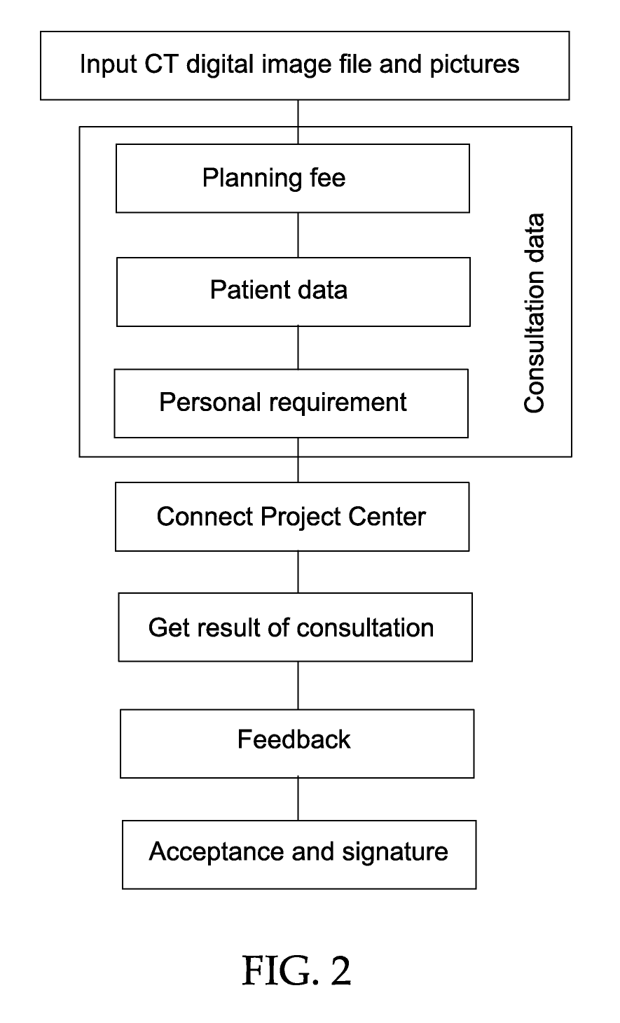

The patient-end terminal 3 is connectable to the network 1 for the input of the CT digital image file and pictures of the patient teeth obtained from the computerized tomography scanner 2 and transmission of the CT digital image file and pictures and a consultation data to the Project Center 4 through the network 1. As illustrated in FIG. 2, the CT digital image file and pictures are inputted into the patient-end terminal 3 at first, and then the consultation data is inputted into the patient-end terminal 3. The consultation data includes planning fee, patient data and personal requirements. After connection to the Project Center, get the result of consultation. At this time, the result of consultation is fed back for patient's acceptance and signature.

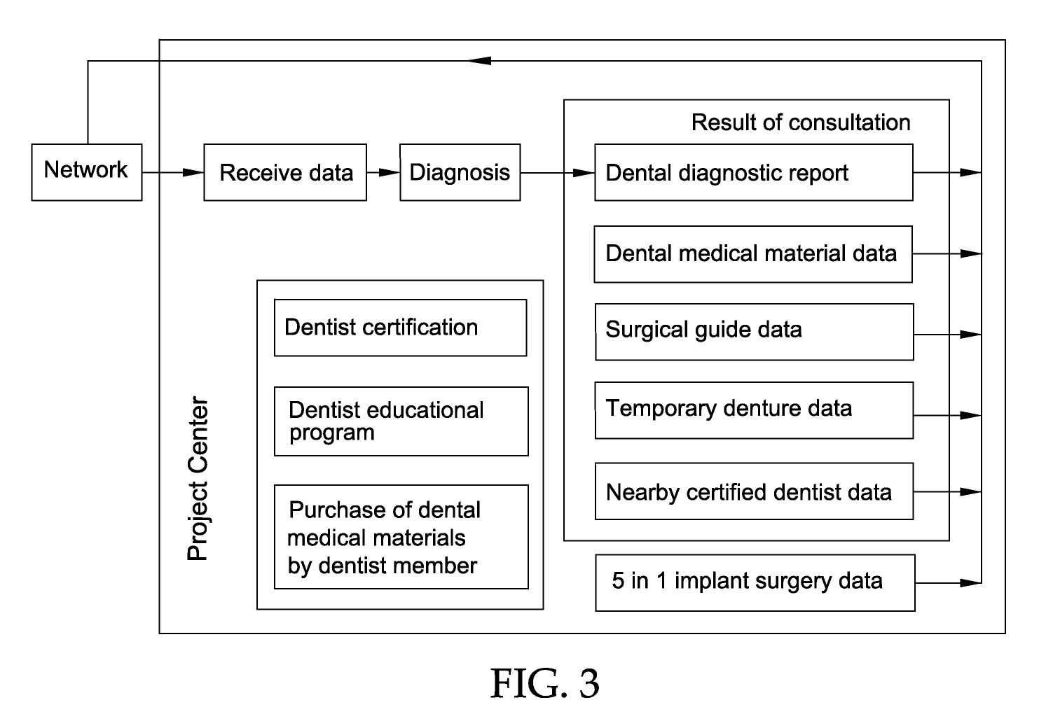

The Project Center 4, as shown in FIG. 3, receives the consultation data and the CT digital image file and pictures from the patient-end terminal 3 via the network 1, and then starts diagnosing subject to the consultation data and the CT digital image file and pictures, and then provides a result of consultation to the patient-end terminal 3 via the network 1. The result of consultation includes dental diagnostic report, dental medical material data, surgical guide data, temporary denture data, certified dentist data and 5-in-1 dental implant surgery data.

The 5-in-1 dental implant surgery is a rapid dental implant technique, and its surgery cost is relatively higher than conventional techniques. With respect to 5-in-1 dental implant surgery, please refer to the applicant's US Patent Publication number 2009 0258328 A1, entitled “5-in-1 dental implant method and apparatus”, and Taiwan Patent number I 305721, entitled “Sinus lift tool for dental implant surgery”.

Further, the certified dentist data provided by the Project Center 4, as shown in FIG. 3, includes dentist certification, dentist educational program, and purchase of dental medical materials by dentist member, i.e., when a dentist is certified by the Project Center 4, the dentist must continuously receive post-dentist education in order to maintain effectiveness of the certification for providing advanced medical and dental care services. After having been certified to become a dentist member of the Project Center 4, he (she) can purchase implant roots from the Project Center 4 at a relatively lower price. The Project Center 4 can offer cheaper implant roots just because of group purchase.

The dental consultation system provided by the present invention has the following advantages:
1. Instead of spending much time and money to consult many dental clinics, any patient can obtain a reliable dental diagnostic report from the Project Center through a network after spent a limited amount of fee to get a CT digital image file and pictures of his (her) teeth from any local dental clinic and then carry the dental diagnostic report to a nearby certified dentist for implant surgery, saving much time and money.
2. A certified dentist can directly start implant surgery after having inspected the dental diagnostic report given by the patient without making any diagnosis from the beginning, thereby saving much labor and time.
3. A certified dentist must be continuously re-educated by the Project Center to get latest medical information, maintaining the leadership in technology.
4. After becoming a member of the Project Center, a dentist can purchase implant roots from the Project Center at a relatively lower price, lowering the medical cost.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A dental consultation system, comprising:
a network;
a computerized tomography scanner adapted for obtaining a CT digital image file and pictures of the teeth in the oral cavity of a patient;
a patient-end terminal for the input of the CT digital image file and pictures of a patient teeth that were obtained from said computerized tomography scanner and a consultation data;
a Project Center for receiving the CT digital image file and pictures and consultation data transmitted by said patient-end terminal through the Internet and then providing a result of consultation and feeding said result of consultation back to said patient-end terminal, said result of consultation comprising a dental diagnostic report, a dental medical material data, a surgical guide data, a temporary denture data, a certified dentist data and a 5-in-1 dental implant surgery data.

2. The dental consultation system as claimed in claim 1, wherein the CT digital image file and pictures of the patient are inputted into said patient-end terminal at first, and then said consultation data is inputted into said patient-end terminal for transmitting to said Project Center through the Internet, said consultation data comprising a planning fee, a patient data and personal requirements; said result of consultation is fed back by said Project center to said patient-end terminal for patient's acceptance and signature.

3. The dental consultation system as claimed in claim 1, wherein said certified dentist data provided by said Project Center comprises a dentist certification, a dentist educational program, and purchase of dental medical materials by dentist member.
